(19) United States
(12) Patent Application Publication
(10) Pub. No.: US 2026/0344938 A1
(43) Pub. Date: Nov. 5, 2026

(54) BLENDER SYSTEMS INCORPORATING SOUND ABSORBING MATERIALS

(71) Applicant: VITA-MIX MANAGEMENT CORPORATION, Olmsted Township, OH (US)

(72) Inventors: Charles Joseph Tromm, Olmsted Township, OH (US); Bradford Paskert, Strongsville, OH (US); Brandon Philip Krise, Middleburg Heights, OH (US); Jacob George Ulmenstine, Olmsted Township, OH (US); Kyle Clancy Jones, Olmsted Township, OH (US); Christian Connell Stewart, Olmsted Township, OH (US); Casey T. Zale, Olmsted Township, OH (US); Trevor Brent Youngmann, Olmsted Township, OH (US); John Edward Chancey, IV, Olmsted Township, OH (US); Carson Athos McCandless, Olmsted Township, OH (US); Kellen Reusser, Olmsted Township, OH (US); Adam Michael Abele, Olmsted Township, OH (US)

(73) Assignee: VITA-MIX MANAGEMENT CORPORATION, Olmsted Township, OH (US)

(21) Appl. No.: 19/487,811

(22) PCT Filed: May 31, 2024
(86) PCT No.: PCT/US2024/031976

§ 371 Date: Nov. 25, 2025

Related U.S. Application Data
(60) Provisional application No. 63/505,676, filed on Jun. 1, 2023.

(51) Int. Cl. A47J 43/07; A47J 43/046

(52) U.S. Cl. CPC A47J 43/0716; A47J 43/046

(57) ABSTRACT

A blender system (100) includes a container (110) supported on a blender base (120). The container (110) includes an inner shell (124) defining an interior cavity and an outer shell (126) disposed with respect to the inner shell (124) to define a gap (128) between the inner shell (124) and the outer shell (126). The container (110) further includes a dampening material (130) disposed within the gap (128) between the inner shell (124) and the outer shell (126). The dampening material (130) forms a non-rigid connection between the inner shell (124) and the outer shell (126).

### CROSS-REFERENCE TO RELATED APPLICATION

This application claims priority to U.S. Provisional Patent Application No. 63/505,676 filed on Jun. 1, 2023, entitled “SOUND REDUCING BLENDER CONTAINERS,” the entire disclosure of which is incorporated herein by reference.

### TECHNICAL FIELD

The present specification generally relates to blender systems and, more specifically, to components within a container and base of a blender system.

### BACKGROUND

Blender systems are often used to blend and process foodstuffs, and may be designed for home use, commercial use, or both. Conventional blenders generally include a container and a base with a motor therein. Operation of the motor can cause excessive noise, which can be deleterious to an operator and/or individuals in the vicinity of the blender system. When utilized in a retail environment, such as restaurants, coffee shops, smoothie shops, and the like, such excessive noise may make it difficult for individuals to hear a customer's order, impact customer conversations, or the like.

The primary source of the sound is from the blade when it is spun. Conventional attempts to dampen this sound included altering the shell and skirt around the blade. However, the shell and skirt alone only respond to vibrations minimally. In addition, operation of the motor can also cause the container or lid to vibrate. Therefore, there exists a need to dampen sound in other ways, such as the walls of the container and/or the lid, which may supplement the shell and skirt sound dampening or may be used in lieu of the shell and skirt sound dampening. As will be appreciated, vibration of the motor, container, and/or lid may cause excessive noises. Rigid connections between various components of the blender system may cause such a noise.

Therefore, a need exists for a sound dampening materials and non-rigid connections to be integrated within a blender system to reduce noise production.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a front view of an illustrative blender system according to one or more aspects shown and described herein;

FIG. 2 depicts a cutaway side view of an illustrative container of a blender system according to one or more aspects shown and described herein;

FIG. 3 depicts a cutaway side view of an illustrative container of a blender system with a lid attached thereon according to one or more aspects shown and described herein;

FIG. 4 depicts a cutaway side view of the bottom of the illustrative container of FIG. 3 according to one or more aspects shown and described herein;

FIG. 5 depicts a cutaway side view of the bottom of the container of FIG. 4 with a blade assembly disposed therein according to one or more aspects shown and described herein;

FIG. 6 depicts a cutaway side view of a base of an illustrative container having a gasket according to one or more aspects shown and described herein;

FIG. 7 depicts a cutaway side view of a base of an illustrative container having an elastomer base according to one or more aspects shown and described herein;

FIG. 8 graphically depicts sound data among different blender configurations according to one or more aspects shown and described herein; and

FIG. 9 graphically depicts sound data among different blender systems according to one or more aspects shown and described herein.

### DETAILED DESCRIPTION

The present disclosure relates to a dampening material disposed in the container and blender base of a blender system. The dampening material dampens vibrations and sounds emanating from the container and the blender base. The dampening material may also be used within a lid of the container. As a result, the blender system disclosed herein, when operated, emits sound at a lower level (e.g., lower decibel) relative to conventional blender systems that do not utilize the dampening material as disclosed herein.

It should be appreciated that while the various embodiments and aspects described herein relate particularly to blender systems, the present disclosure is not limited to such. That is, the various components, systems, and methods described herein can be implemented in other manners, such as other motor driven devices or systems.

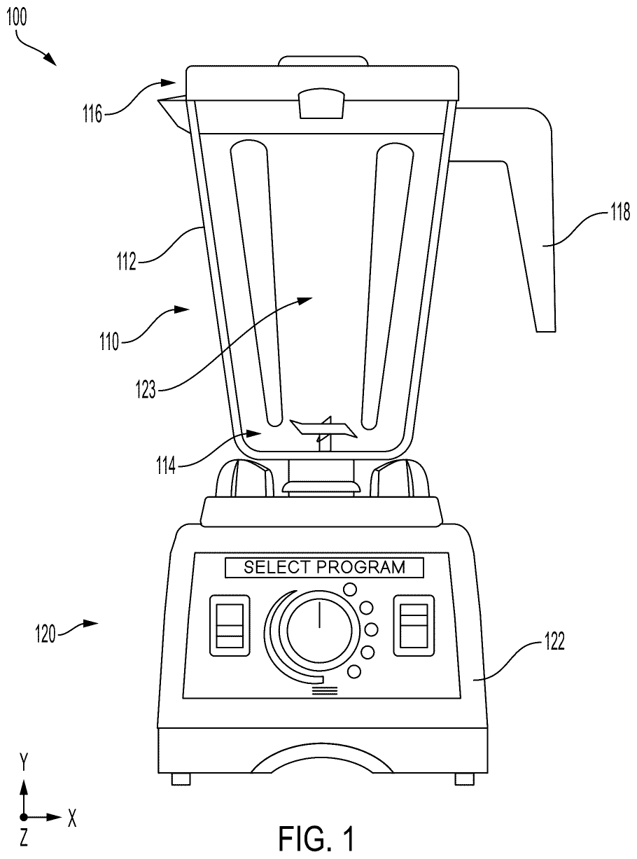

FIG. 1 generally depicts an illustrative blender system 100 according to various embodiments. The blender system 100 depicted in FIG. 1 may incorporate one or more sound dampening components, as described in greater detail herein. The blender system 100 depicted in FIG. 1 is provided for context only, and the sound dampening components described herein are not limited to this implementation. For example, blender system 100 may include a large format container, or other blending container as described herein. In addition, the blender system 100 may allow for interchangeable containers.

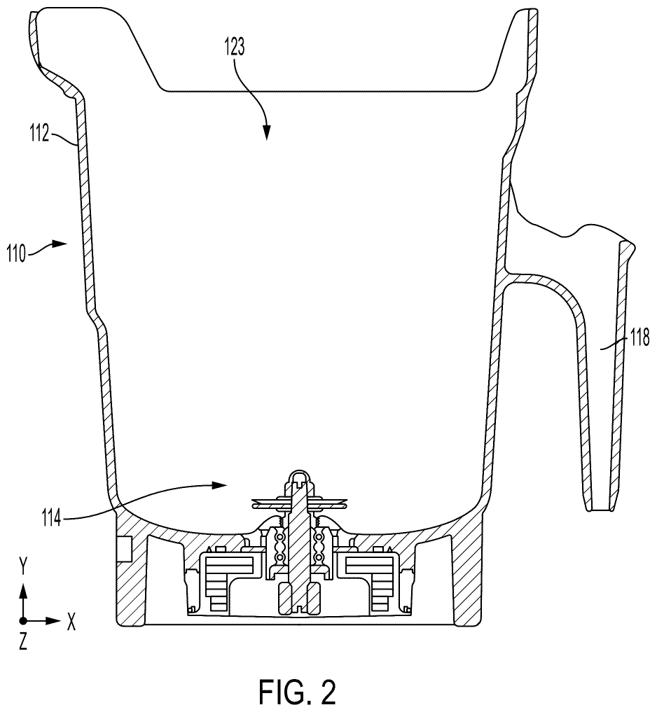

As shown in FIGS. 1-2, the blender system 100 includes a blender base 120 and a container 110 (also referred to herein as a blender container) operatively attachable to the blender base 120. The container 110 includes walls 112 that define an interior cavity 123 containing a blade assembly 114. In addition, the blender system 100 includes a lid 116 that may be operatively attached to the container 110 to enclose the interior cavity 123 defined by the walls 112. The container 110 may further include a handle 118. Foodstuff and/or other items may be added to the interior cavity 123 of the container 110 for blending. The container 110 may be formed from one or more materials such as, but not limited to, plastics, glass, metals, or the like. In another aspect, the container 110 may be powered in any appropriate manner, such as by components within the blender base 120, as described herein.

In some embodiments, the blade assembly 114 is removably couplable to the container 110. In addition, the container 110 may be removably couplable to the blender base 120. The blade assembly 114 may be rotated, moved, or the like by an external source, such as a motor or the like, such as a motor housed within the blade assembly 114.

While the container 110 depicted in FIG. 1 and FIG. 2 is shown as a large-format system, the container 110 may be a single serving style container, such as for example, of a type where the container 110 is filled, a blender base containing the blade assembly 114 is attached to the container, and the container 110 is inverted and placed on the blender base 120 for blending. As can be appreciated, the container 110 depicted in FIG. 1 and FIG. 2 is only one illustrative shape, and the container 110 may be a different size and/or shape without departing from the scope of the present disclosure.

Referring again to FIG. 1, the blender base 120 includes a motor (not depicted) disposed within a housing 122. The motor selectively drives the blade assembly 114 when the blade assembly 114 is interfaced with the blender base 120. As a result, the blade assembly 114 may agitate, impart heat, or otherwise interact with contents within the interior cavity 123 of the container 110. In some aspects, operation of the blender system 100 may impart heat into the contents within the interior cavity 123 of the container 110, such as through a magnet and an exciter that operatively induce heat through rotation of the magnet relative the exciter.

In some embodiments, the blender system 100 may include a detection feature that identifies or detects whether the blender system 100 is interlocked through mechanical detection (e.g., push rods), user input, image recognition, magnetic detection (e.g., reed switches), electronic detection (e.g., inductive coils, a near field communication (NFC) component), or the like.

Referring now to FIG. 2, a cutaway side view of the illustrative container 110 of FIG. 1 is depicted. Specifically, the container 110 includes a single wall 112 that defines the interior cavity 123. Various components of the container of FIG. 2 may be integrated into the blender system 100 and container 110 described herein.

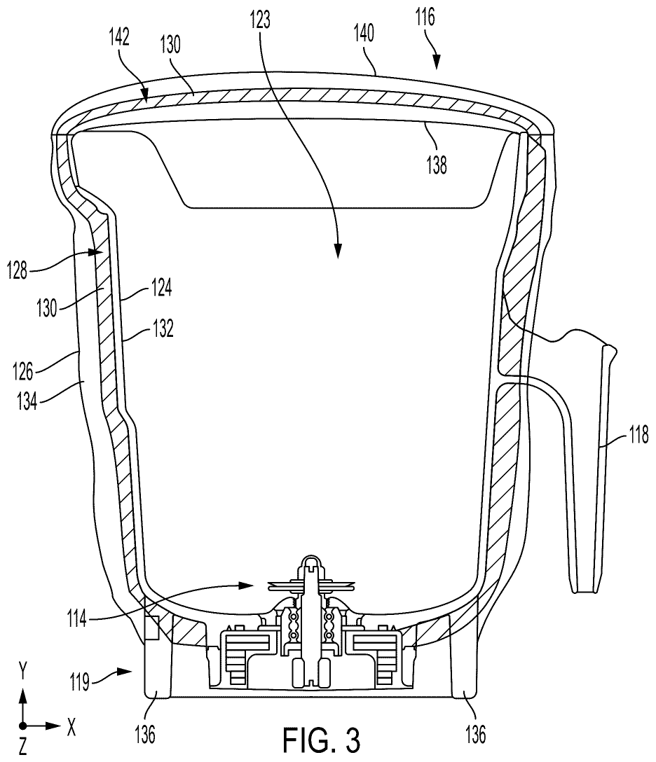

Referring now to FIG. 3, the blender system 100 of the current disclosure includes sound insulation features within the container 110. Specifically, the container 110 includes an inner shell 124 and an outer shell 126, such as an inner wall and an outer wall (in contrast to the single wall 112 as noted hereinabove in FIG. 2). The outer shell 126 is disposed with respect to the inner shell 124 to define a gap 128 between the inner shell 124 and the outer shell 126. A dampening material 130 is disposed within the gap 128, such that the dampening material 130 forms a non-rigid connection between the inner shell 124 and the outer shell 126. It should be understood that features described with respect to the container of FIG. 2 may be included in the blender system 100 of FIG. 3, such as the detection feature, the blade assembly 114, the handle 118, or the lid 116.

The non-rigid connection between the inner shell 124 and the outer shell 126 provide for decreased vibrations of the inner shell 124 and the outer shell 126. The non-rigid connection between the inner shell 124 and the outer shell 126 permits movement of the inner shell 124 and the outer shell 126 with respect to one another while still maintaining a connection between the inner shell 124 and the outer shell 126. As such, the dampening material 130 (discussed further below) disposed between the inner shell 124 and the outer shell 126 absorbs vibrations and/or sounds from each of the inner shell 124 and the outer shell 126. In contrast, a rigid connection would not permit such movement/dampening. The decreased vibrations increase sound dampening, reducing sound emanating from the blender system 100 (as provided for and discussed further herein herein).

The inner shell 124 defines the interior cavity 123, which houses the contents placed within the container 110. As such, the inner shell 124 may be made of the same or differing material with respect to the outer shell 126. For example, the inner shell 124 may be made of a first material 132 and the outer shell 126 may be made of a second material 134. The first material 132 may be of higher quality (e.g., more corrosion resistant, more resistant to damage, formed from a more durable material, etc.) than the second material 134, since the first material 132 interacts with the contents of the blender system 100. The first material 132 may be made of a food safe material, such as glass, plastic, metal, or any other suitable material. Food safe material may be any material that may be in contact with foodstuffs without contaminating the foodstuffs, such that the foodstuffs is safe for human consumption after being in contact with the food safe material. Food safe material may be defined by governing bodies, such as the Federal and Drug Administration, U.S. Department of Agriculture, or any other governing body. In embodiments, the second material 134 may be made of a non-food safe material (e.g., cheaper material), since the second material 134 does not interact with the contents of the interior cavity 123. This may reduce costs of manufacturing the blender system 100 described herein. The second material 134 may include glass, rubber, plastic, metal, or any other suitable material. The inner shell 124 and the outer shell 126 may be molded, casted, or 3-D printed.

The inner shell 124 and the outer shell 126 may be of varying thicknesses. In embodiments, the inner shell 124 and the outer shell 126 may be 0.25 centimeters thick, 0.5 centimeters thick, 1.0 centimeters thick, 1.5 centimeters thick, 2.0 centimeters thick, or even 2.5 centimeters thick. Moreover, dimensions of the outer shell 126 may be generally larger than the dimensions of the inner shell 124, such that the gap 128 is formed between the inner shell 124 and the outer shell 126. The gap 128 between the inner shell 124 and the outer shell 126 may be 0.25 centimeters thick, 0.5 centimeters thick, 1.0 centimeters thick, 1.5 centimeters thick, 2.0 centimeters thick, or even 2.5 centimeters thick.

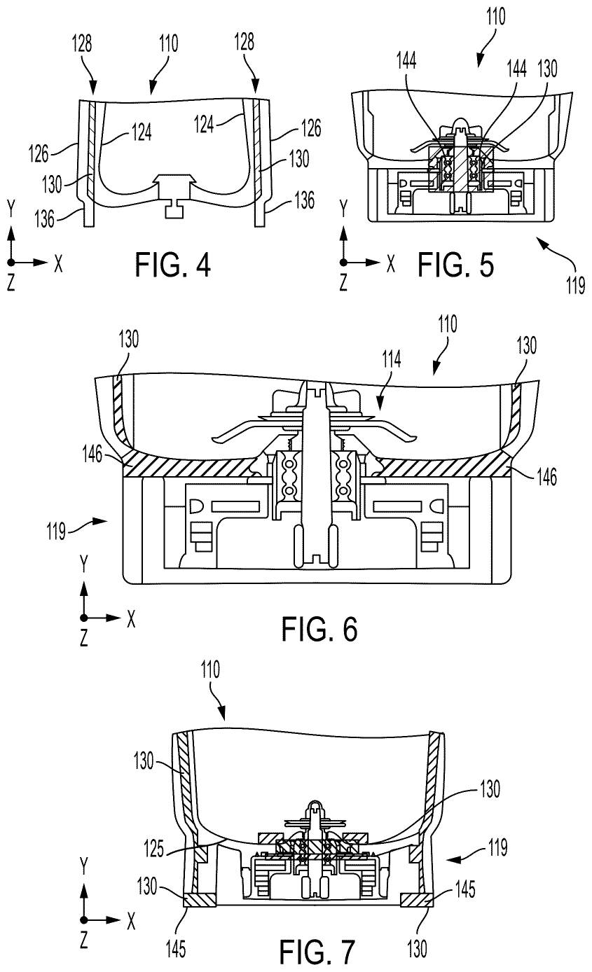

Referring now to FIGS. 4 and 5, the outer shell 126 may include a container skirt 136. The container skirt 136 may extend in the downward direction toward the blender base 120 (e.g., in the-y direction of the coordinate axes of FIG. 3). The container skirt 136 may further dampen noises produced by the blender base 120. In embodiments, the dampening material 130 may extend over the container skirt 136. The container skirt 136 may extend in the downward direction such that the container skirt 136 partially or entirely encloses a lower portion 119 of the container 110.

Referring again to FIG. 3, the blender system 100 may also include the lid 116. The lid 116 may be selectively couplable to the inner shell 124 or the outer shell 126, such that the lid 116 encloses the interior cavity 123 when the lid is coupled to the inner shell 124 or the outer shell 126. The lid 116 may be coupled to the inner shell 124 or the outer shell 126 through a lip seal 117. The lip seal 117 may extend around the lid 116, the inner shell 124, or the outer shell 126. The lip seal 117 may be made of elastomeric isomers or any suitable type of rubber. The lip seal 117 generally provides a seal between the lid 116 and the inner shell 124 and outer shell 126. Such a seal functions to contain the contents of the blender system 100 within the interior cavity 123, as well as dampens sounds generated by the motor and blade assembly 114 of the blender base 120 or the container 110. In embodiments, the lip seal 117 may be in contact with an inner surface of the inner shell 124, such as to seal the interior cavity 123.

The lid 116 may include an inner lid shell 138 and an outer lid shell 140. The outer lid shell 140 may be separated from the inner lid shell 138 to form a lid gap 142 (similar to the gap 128 formed from the inner shell 124 and the outer shell 126 of the container 110). The dampening material 130 may be disposed within the lid gap 142, such that a non-rigid connection exists between the inner lid shell 138 and the outer lid shell 140. Such a non-rigid connection provide for decreased vibrations within the lid 116 and, thus, increased sound dampening in the lid 116.

The lid may be made of the same or different material than the inner shell 124 or the outer shell 126. In embodiments, the inner lid shell 138 may be made of the same material as the inner shell 124 of the container 110, while the outer lid shell 140 is made of the same material as the outer shell 126 of the container 110. The inner lid shell 138 and the outer lid shell 140 may be of varying thicknesses. In embodiments, the inner lid shell 138 and the outer lid shell 140 may be 0.25 centimeters thick, 0.5 centimeters thick, 1.0 centimeters thick, 1.5 centimeters thick, 2.0 centimeters thick, or even 2.5 centimeters thick. Dimensions of the outer lid shell 140 may be generally larger than dimensions of the inner lid shell 138, such as to form the lid gap 142. The lid gap 142 between the inner lid shell 138 and the outer lid shell 140 may be 0.25 centimeters thick, 0.5 centimeters thick, 1.0 centimeters thick, 1.5 centimeters thick, 2.0 centimeters thick, or even 2.5 centimeters thick.

Referring again to FIG. 3, the dampening material 130 may be disposed between the inner shell 124 and the outer shell 126 of the container 110 or between the inner lid shell 138 and the outer lid shell 140 of the lid 116. The dampening material 130 may dampen both sounds and vibrations coming from the container 110 and/or the lid 116. As such, the dampening material 130 may include sound dampening material or vibration dampening material.

The dampening material 130 may include an open cell foam or a closed cell foam. As described herein, closed cell foam is generally denser than open cell foam, as open cell foam may allow air/materials to pass through, while closed cell foam does not allow air/other materials to pass through. Open cell foam may also have an interconnected porous network, while closed cell foam has hollow cells that are not connected to one another. The dampening material 130 provides for a non-rigid connection between the inner shell 124 and the outer shell 126 of the container 110 or between the inner lid shell 138 and the outer lid shell 140 of the lid 116, decreasing vibrations among components within the blender system 100. The dampening material 130 may be placed within the gap 128 or the lid gap 142 through various methods/processes.

The dampening material 130 may be placed into the gap 128 or the lid gap 142 through injection. Specifically, the dampening material 130 may be in liquid form before it is injected into the gap 128 or the lid gap 142. The dampening material 130 may be injected into the gap 128 as a liquid, then cure as a foam once injected into the gap 128 or the lid gap 142. The dampening material 130 may also be placed within the gap 128 through fasteners, adhesives, or any other suitable means.

As noted hereinabove, the dampening material 130 may be an open cell foam or a closed cell foam. More specifically, the dampening material 130 may be ballistic gel, open cell foam, closed cell foam, expanding foam, silicone, caulk, plastics, air, or any other suitable sound dampening material. The dampening material 130 may be 0.25 centimeters thick, 0.5 centimeters thick, 1.0 centimeters thick, 1.5 centimeters thick, 2.0 centimeters thick, or even 2.5 centimeters thick.

Referring now to FIGS. 5-7, the lower portion 119 of the container 110 is depicted. The lower portion 119 of the container 110 may also include the dampening material 130 in various portions. For example, as depicted in FIG. 5, the lower portion 119 of the container 110 may include one or more bearings 144. The bearings 144 reduce friction and facilitate rotation of the blade assembly 114; thus, the bearings 144 may be a source of noise within the container 110 and/or blender base 120 because the bearings 144 are moving as the blade assembly 114 is activated. As such, the dampening material 130 may surround the bearings 144 of the container 110 or blender base 120 to reduce sound production of the container 110 or the blender base 120. The dampening material 130 surround all of the bearings 144 or only a portion of the bearings 144. Moreover, the dampening material 130 does not hinder operation of the bearings 144, such that the bearings 144 continue to reduce friction and facilitate rotation of the blade assembly 114 as if the dampening material 130 was not surrounding the bearings 144.

Referring now to FIG. 6, in embodiments, a gasket 146 may be disposed between the inner shell 124 and the lower portion 119 of the container 110. The gasket 146 may include the dampening material 130 and/or other material, and may function to further reduce vibrations and, thus, reduce sound emanating from the blender system 100. The gasket 146 may be coupled to the inner shell 124 of the container 110 or the lower portion 119 of the container 110. In embodiments, the gasket 146 may also extend down (e.g., in the −y direction of the coordinate axes of FIG. 6) the container skirt 136, such that the gasket 146 is also connected to the outer shell 126 of the blender base 120. The gasket may be 0.25 centimeters thick, 0.5 centimeters thick, 1.0 centimeters thick, 1.5 centimeters thick, 2.0 centimeters thick, or even 2.5 centimeters thick.

As depicted in FIG. 7, the dampening material 130 may surround the bearings 144 as an elastomer base 145. The elastomer base 145 may surround the lower portion 119 of the container 110, such that the elastomer base 145 extends around the container skirt 136. In other embodiments, the dampening material 130 may be positioned on a bottom 125 of the inner shell 124, such as to reduce vibrations between the inner shell 124 and the lower portion 119 of the container 110. The dampening material 130 may also be positioned between the container 110 and the blender base 120.

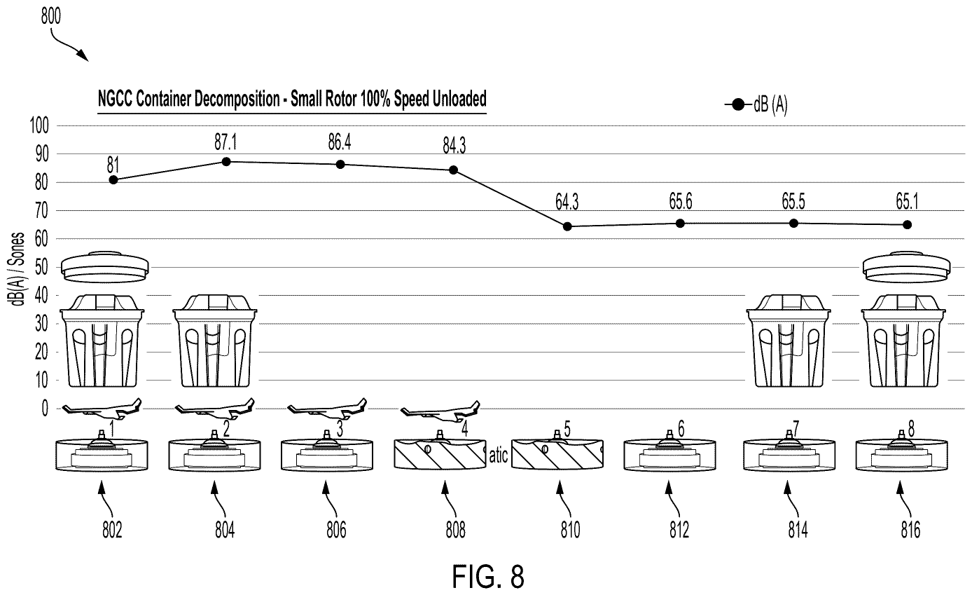

Referring now to FIG. 8, a first chart 800 showing sound reduction of the blender system 100 is depicted. Specifically, the first chart 800 compares various blender system configurations (x-axis) and the sound amplitude (as measured by a microphone) produced in decibels (dB) (y-axis). The blender configurations include a first blender configuration 802, a second blender configuration 804, a third blender configuration 806, a fourth blender configuration 808, a fifth blender configuration 810, a sixth blender configuration 812, a seventh blender configuration 814, and an eighth blender configuration 816, as depicted on the x-axis of FIG. 8. The first blender configuration 802 with a blender base 120, blade assembly 114, container 110, and lid 116 produced 81 dB. When the lid 116 was removed in the second blender configuration 804, the blender system 100 produced 87.1 dB. When the container 110 was removed, the third blender configuration 806 produced 86.4 dB. This illustrates that the container 110 is a source of sound production within the blender system 100.

Moreover, insulation of the blender base 120 in the fourth blender configuration 808 reduces sound production to 84.3 dB. Once the blade assembly 114 was removed between the fourth blender configuration 808 and the fifth blender configuration 810, the sound was reduced from 84.3 dB to 64.3 dB. The seventh blender configuration 814 and the eighth blender configuration 816 utilize the dampening material 130 disclosed herein. Thus, compared to the first blender configuration 802 and the second blender configuration 804 that do not utilize the dampening material 130, sound production of the blender system 100 is reduced by between 15.9 dB and 21.6 dB in the seventh blender configuration 814 and the eighth blender configuration 816 that utilize the dampening material 130 disclosed herein.

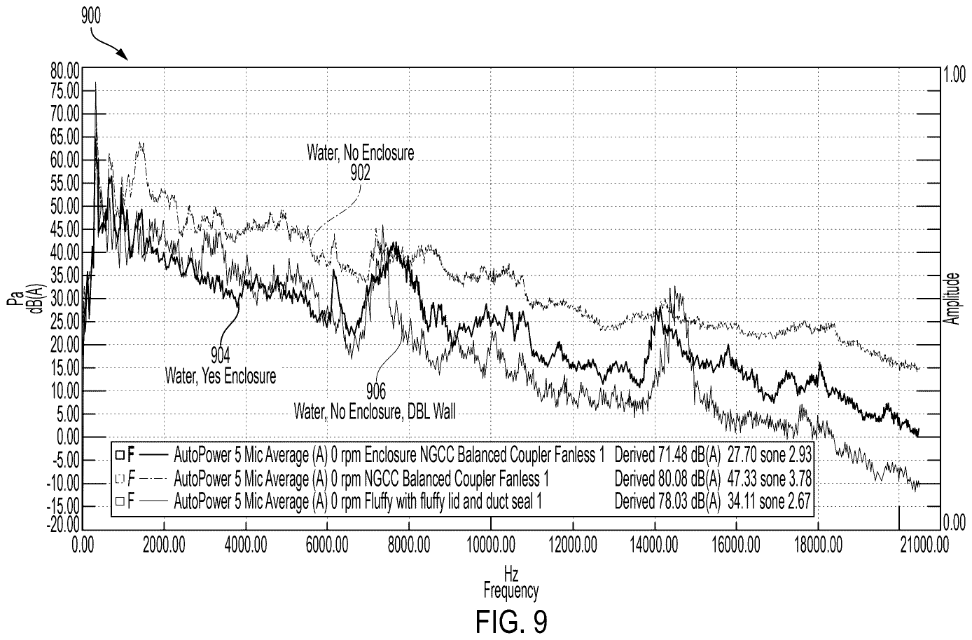

Referring now to FIG. 9, a second chart 900 showing sound reduction of the blender system 100 is depicted. Specifically, the second chart 900 compares the frequency at which the blender is run (x-axis) and the sound amplitude (as measured by a microphone) produced in dB (y-axis) for various blender systems 100. Water was used in the blending processes depicted in the second chart 900. A first blender configuration 902 has no lid 116, a second blender configuration 904 has the lid 116, and the third blender configuration 906 has a lid 116 and the dampening material 130 described herein. As is reflected in the second chart 900, a reduction in sound production is achieved through use of the lid 116 and the dampening material 130 added to the blender system 100.

In some embodiments, the present disclosure relates to a method of assembling the various components of the blender system 100 shown and described herein. The blender system 100 may be formed by disposing the inner shell 124 within the outer shell 126 to define the gap 128 between the inner shell 124 and the outer shell 126. The method may further include injecting the dampening material 130 within the gap 128 between the inner shell 124 and the outer shell 126. The method may then include curing the dampening material 130 between the inner shell 124 and the outer shell 126. The method also include disposing the inner lid shell 138 within the outer lid shell 140 to form the lid gap 142 between the inner lid shell 138 and the outer lid shell 140 and then injecting the dampening material 130 within the lid gap 142 between the inner lid shell 138 and the outer lid shell 140. The method may then include curing the dampening material 130 between the inner lid shell 138 and the outer lid shell 140.

Based on the foregoing, it should now be understood that the present disclosure relates to a blender container and a blender system comprised of an inner shell, an outer shell, and a dampening material disposed therebetween. The dampening material is designed to reduce vibration and, thus, reduce noise through a non-rigid connected of the inner shell and the outer shell.

Implementation examples are described in the following numbered clauses:

Clause 1: A blender system, comprising: a container supported on a blender base, the container comprising: an inner shell defining an interior cavity; an outer shell disposed with respect to the inner shell to define a gap between the inner shell and the outer shell; and a dampening material disposed within the gap between the inner shell and the outer shell, wherein the dampening material forms a non-rigid connection between the inner shell and the outer shell.

Clause 2: The blender system of clause 1, wherein the dampening material is a sound dampening material or a vibration dampening material.

Clause 3: The blender system of clause 1, wherein the dampening material comprises an open cell foam or a closed cell foam.

Clause 4: The blender system of clause 1, wherein the outer shell comprises a container skirt that extends downward toward the blender base.

Clause 5: The blender system of clause 1, further comprising a lid selectively couplable to the inner shell and the outer shell through a lip seal.

Clause 6: The blender system of clause 5, wherein the lid comprises: an inner lid shell; an outer lid shell separated from the inner lid shell to form a lid gap; and the dampening material disposed within the lid gap between the inner lid shell and the outer lid shell, wherein the dampening material forms a non-rigid connection between the inner lid shell and the outer lid shell.

Clause 7: The blender system of clause 1, further comprising a gasket disposed between the inner shell and a lower portion of the container, wherein the gasket comprises the dampening material.

Clause 8: The blender system of clause 1, wherein the dampening material surrounds a bearing of the container.

Clause 9: The blender system of clause 1, wherein the inner shell comprises a first material and the outer shell comprises a second material.

Clause 10: The blender system of clause 9, wherein the first material of the inner shell is a food safe material.

Clause 11: A blender container comprising: an inner shell; an outer shell disposed with respect to the inner shell to define a gap between the inner shell and the outer shell; and a dampening material disposed within the gap between the inner shell and the outer shell, wherein the dampening material forms a non-rigid connection between the inner shell and the outer shell.

Clause 12: The blender container of clause 11, wherein the dampening material is a sound dampening material or a vibration dampening material.

Clause 13: A blender container of clause 11, wherein the dampening material comprises an open cell foam or a closed cell foam.

Clause 14: The blender container of clause 11, further comprising a lid selectively couplable to the inner shell or the outer shell through a lip seal.

Clause 15: The blender container of clause 14, wherein the lid comprises: an inner lid shell; an outer lid shell separated from the inner lid shell to form a lid gap; and the dampening material disposed within the lid gap between the inner lid shell and the outer lid shell, wherein the dampening material forms a non-rigid connection between the inner lid shell and the outer lid shell.

Clause 16: The blender container of clause 11, wherein the outer shell comprises a container skirt that extends downward toward the blender base.

Clause 17: The blender container of clause 16, wherein the dampening material extends along the container skirt.

Clause 18: A blender container comprising an inner shell; an outer shell disposed with respect to the inner shell to define a gap between the inner shell and the outer shell, wherein the outer shell comprises a container skirt that extends downward toward the blender base; a lid selectively couplable to the inner shell and the outer shell through a lip seal; and a dampening material disposed within the gap between the inner shell and the outer shell, wherein the dampening material forms a non-rigid connection between the inner shell and the outer shell.

Clause 19: The blender container of clause 18, wherein the dampening material extends along the container skirt.

Clause 20: The blender container of clause 18, wherein the lid comprises: an inner lid shell; an outer lid shell separated from the inner lid shell to form a lid gap; and the dampening material disposed within the lid gap between the inner lid shell and the outer lid shell, wherein the dampening material forms a non-rigid connection between the inner lid shell and the outer lid shell.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A blender system, comprising:
a container supported on a blender base, the container comprising:
an inner shell defining an interior cavity;
an outer shell disposed with respect to the inner shell to define a gap between the inner shell and the outer shell; and
a dampening material disposed within the gap between the inner shell and the outer shell, wherein the dampening material forms a non-rigid connection between the inner shell and the outer shell.

2. The blender system of claim 1, wherein the dampening material is a sound dampening material or a vibration dampening material.

3. The blender system of claim 1, wherein the dampening material comprises an open cell foam or a closed cell foam.

4. The blender system of claim 1, wherein the outer shell comprises a container skirt that extends downward toward the blender base.

5. The blender system of claim 1, further comprising a lid selectively couplable to the inner shell or the outer shell through a lip seal.

6. The blender system of claim 5, wherein the lid comprises:
an inner lid shell;
an outer lid shell separated from the inner lid shell to form a lid gap; and
the dampening material disposed within the lid gap between the inner lid shell and the outer lid shell, wherein the dampening material forms a non-rigid connection between the inner lid shell and the outer lid shell.

7. The blender system of claim 1, further comprising a gasket disposed between the inner shell and a lower portion of the container, wherein the gasket comprises the dampening material.

8. The blender system of claim 1, wherein the dampening material surrounds a bearing of the container.

9. The blender system of claim 1, wherein the inner shell comprises a first material and the outer shell comprises a second material.

10. The blender system of claim 9, wherein the first material of the inner shell is a food safe material.

11. A blender container, comprising:
an inner shell;
an outer shell disposed with respect to the inner shell to define a gap between the inner shell and the outer shell; and
a dampening material disposed within the gap between the inner shell and the outer shell, wherein the dampening material forms a non-rigid connection between the inner shell and the outer shell.

12. The blender container of claim 11, wherein the dampening material is a sound dampening material or a vibration dampening material.

13. The blender container of claim 11, wherein the dampening material comprises an open cell foam or a closed cell foam.

14. The blender container of claim 11, further comprising a lid selectively couplable to the inner shell or the outer shell through a lip seal.

15. The blender container of claim 14, wherein the lid comprises:
an inner lid shell;
an outer lid shell separated from the inner lid shell to form a lid gap; and
the dampening material disposed within the lid gap between the inner lid shell and the outer lid shell, wherein the dampening material forms a non-rigid connection between the inner lid shell and the outer lid shell.

16. The blender container of claim 11, wherein the outer shell comprises a container skirt that extends downward toward the blender base.

17. The blender container of claim 16, wherein the dampening material extends along the container skirt.

18. A blender container, comprising:
an inner shell;
an outer shell disposed with respect to the inner shell to define a gap between the inner shell and the outer shell, wherein the outer shell comprises a container skirt that extends downward toward the blender base;
a lid selectively couplable to the inner shell or the outer shell through a lip seal; and
a dampening material disposed within the gap between the inner shell and the outer shell, wherein the dampening material forms a non-rigid connection between the inner shell and the outer shell.

19. The blender container of claim 18, wherein the dampening material extends along the container skirt.

20. The blender container of claim 18, wherein the lid comprises:
an inner lid shell;
an outer lid shell separated from the inner lid shell to form a lid gap; and
the dampening material disposed within the lid gap between the inner lid shell and the outer lid shell, wherein the dampening material forms a non-rigid connection between the inner lid shell and the outer lid shell.
